(19) United States
(12) Patent Application Publication
(10) Pub. No.: US 2020/0233669 A1
(43) Pub. Date: Jul. 23, 2020

(54) PROCESSOR SYSTEM AND MULTIPROCESSOR SYSTEM

(71) Applicant: OSCAR TECHNOLOGY CORPORATION, Tokyo (JP)

(72) Inventors: Toshiaki Kitamura, Tokyo (JP); Takashi Mochiyama, Tokyo (JP)

(21) Appl. No.: 16/486,298

(22) PCT Filed: Feb. 16, 2017
(86) PCT No.: PCT/JP2017/005790

§ 371 Date: Aug. 15, 2019

(51) Int. Cl. G06F 9/30; G06F 9/48; G06F 9/38; G06F 9/54

(52) U.S. Cl. CPC G06F 9/30189; G06F 9/4893; G06F 9/544; G06F 9/3001; G06F 9/3877

(57) ABSTRACT

A processor system (200) includes one task execution unit (220), another task execution unit (250), and a flag storage unit (230) provided with a control unit (232) and a flag area (234). When flag information stored in the flag area (234) does not satisfy a predetermined condition, the one task execution unit (220) outputs, to the control unit (232), a signal indicating that the flag information is being monitored, and suspends access to the flag information. The control unit (232) monitors the presence or absence of access to the flag information from the other task execution unit (250), and when there is access to the flag information, the control unit (232) outputs, to the one task execution unit (220), an instruction to release the suspension of access to the flag information.

### TECHNICAL FIELD

The present invention relates to a processor system and a multiprocessor system.

### BACKGROUND ART

Conventionally, a processor system has been known, which includes a task execution unit operating according to a task included in a program to operate independently of any other task execution unit.

For example, a processor system is disclosed in Patent Literature 1, which includes a data transfer unit as a task execution unit operating according to a task included in a program for the data transfer unit created by a parallelizing compiler.

One aspect of the operation of this data transfer unit disclosed in Patent Literature 1 will be described in brief. When being started, this data transfer unit first reads the program for the data transfer unit. This data transfer unit repeatedly checks a first flag variable area stored in a storage unit of the processor system according to the task included in the program for the data transfer unit. When checking that a flag is written into the first flag variable area, the data transfer unit starts the transfer of predetermined data stored in the storage unit of the processor system.

Since the data transfer unit in Patent Literature 1 operates according to the task included in the program for the data transfer unit, the data transfer unit can operate independently of a processor or an accelerator as any other task execution unit included in the processor system. As a result, since data processing of the other task execution unit and data transfer can be executed in parallel, processing can be speeded up.

Even if respective task execution units operate independently of each other, since data transfer and the like of the data transfer unit can be started by checking the flag information described above after completion of data writing of any other execution unit indicated by the written flag, data processing or transfer contrary to the intention of a program designer is prevented.

### CITATION LIST

### Patent Literature

Patent Literature 1: PCT International Publication No. WO 2013/065687

### SUMMARY OF INVENTION

### Technical Problem

However, upon flag checking, when each task execution unit performs flag checking frequently, there is a possibility that overhead related to flag checking becomes large to reduce the entire processing speed of the processor system or increase power consumption.

On the other hand, when the interval of flag checking by each task execution unit is lengthened to avoid the increase in overhead of flag checking, a deviation occurs between the timing of updating each flag and the timing of flag checking, and hence there is a possibility that unnecessary standby time occurs until execution of a task following the flag checking.

The present invention has been made in view of such problems, and it is an object thereof to provide a processor system including a task execution unit capable of reducing standby time until execution of a task following flag checking while suppressing the overhead of flag checking.

### Solution to Problem

A processor system of the present invention includes:

a plurality of task execution units configured to operate according to tasks included in a program; and

a flag storage unit configured to include a flag area which stores flag information and a control unit which controls access to the flag area, wherein

one task execution unit in the plurality of task execution units determines whether flag information stored in the flag area satisfies a predetermined condition or not according to a flag checking task, and

when the flag information stored in the flag area satisfies the predetermined condition, the one task execution unit starts execution of a task following the flag checking task, or

when the flag information stored in the flag area does not satisfy the predetermined condition, thy; one task execution unit outputs, to the control unit of the flag storage unit, a signal indicating that the flag information is being monitored, and suspends access to the flag information, and

when the signal indicating that the flag information is being monitored is input from the one task execution unit, the control unit of the flag storage unit monitors the presence or absence of access to the flag information from another task execution unit in the plurality of task execution units, and outputs, to the one task execution unit, an instruction to release the suspension of access to the flag information when there is access to the flag information.

According to the processor system thus configured,it is determined by the one task execution unit whether the flag information stored in the flag area of the flag storage unit satisfies the predetermined condition or not according to the flag checking task included in the program.

When the flag information stored in the flag area satisfies the predetermined condition, a task following the flag checking task and included in the program is executed by the one task execution unit.

Thus, the execution start timing of the task following the flag checking task can be adjusted.

On the other hand, when the flag information stored in the flag area does not satisfy the predetermined condition, the one task execution unit outputs, to the control unit of the flag storage unit, the signal indicating that the flag information is being monitored, and suspends access to the flag information.

Then, when the signal indicating that the flag information is being monitored is input from the one task execution unit, the control unit of the flag storage unit monitors the presence or absence of access to the flag information from the other task execution unit.

Then, when there is access to the flag information, the control unit of the flag storage unit outputs, to the one task execution unit, an instruction for releasing the suspension of access to the flag information.

The flag information will not be updated unless there is access to the flag information. Therefore, access to the flag information while the flag information is not updated can be avoided by releasing the suspension of access to the flag information on condition that there is access to the flag information. Thus, the overhead of flag checking can be suppressed compared with the case of frequent access to the flag area. In addition, when the flag information is accessed, that is, when there is a possibility that the flag information satisfies the predetermined condition by changing the flag information or the like, since the suspension of access of the one task execution unit to the flag information is released, standby time until execution of the task following flag checking can be shortened.

It is preferred that the processor system of the present invention be configured to further include

a power supply unit which supplies power to the one task execution unit,

wherein upon suspending access to the flag information, the one task execution unit outputs a signal for reducing or shutting off the amount of power to be supplied from the power supply unit to the one task execution unit.

According to the processor system thus configured, since the one task execution unit outputs the signal for reducing or shutting off the amount of power to be supplied from the power supply unit to the one task execution unit upon suspending access to the flag information, power consumption during the suspension of access to the flag information can be reduced.

It is also preferred that the processor system of the present invention be configured to further include

a program counter which indicates a task to be executed next by the one task execution unit,

wherein the one task execution unit updates the program counter after determining in the flag checking task that the flag information satisfies the predetermined condition, and when there is interrupt processing during the suspension of access to the flag information, the one task execution unit executes the interrupt processing without updating the program counter, and refers to the program counter after completion of the execution of the interrupt processing to recognize the task to be executed next.

According to the processor system thus configured, when there is interrupt processing during the suspension of access to the flag information, the interrupt processing is executed without updating the program counter. After that, the program counter is referred to recognize the task to be executed next.

Here, since the program counter is updated after it is determined in the flag checking task that the flag information satisfies the predetermined condition, the program counter is not updated during the suspension of access to the flag information. In other words, since the task indicated in the program counter remains as the flag checking task during the suspension of access to the flag information, the flag checking task is recognized as the task to be executed next unless the program counter is updated in the interrupt processing after completion of the execution of the interrupt processing.

Since the flag checking task is a task which is not accompanied by updating processing target data, data inconsistency will not occur even if the task is re--executed. This makes it possible to simplify processing at the time of interruption and upon restart of the interruption while executing the interrupt processing properly.

It is further preferred that the processor system of the present invention be configured such that

the processor system is an accelerator provided on a chip,

the flag storage unit is a local memory including the flag area, the control unit, and a data area which stores data different from the flag information,

the one task execution unit is a data transfer unit configured to transfer data from the data area to the outside of the accelerator or transfer data from the outside of the accelerator to the data area, and

the other task execution unit is a calculation unit configured to read data stored in the data area, execute arithmetic processing according to a program based on the read data, store the arithmetic processing result in the data area, and update the value of the flag information.

It is preferred that a multiprocessor system of the present invention should include:

a plurality of the processor systems of the present invention; and

a shared memory accessible from the plurality of the processor systems, respectively.

### BRIEF DESCRIPTION OF DRAWINGS

FIG. 1 is a configuration diagram of a multiprocessor system.

FIG. 2 is a flowchart of data transfer processing.

FIG. 3 is a flowchart of a transfer completion waiting task.

FIG. 4 is a flowchart of a flag checking task.

FIG. 5 is a flowchart of an address check.

### DESCRIPTION OF EMBODIMENT

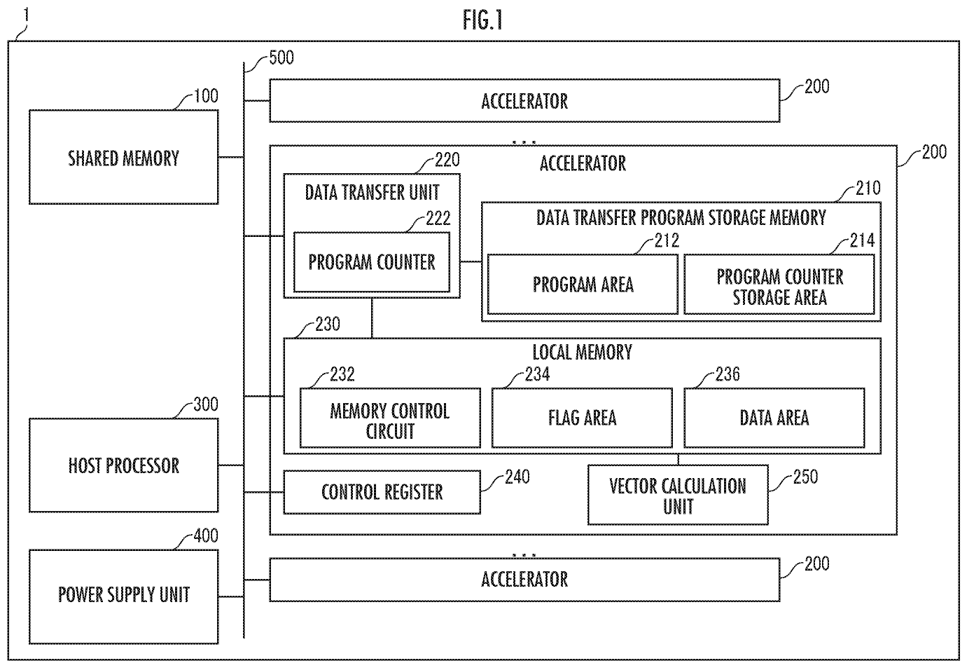

Referring to FIG. 1 to FIG. 5, one embodiment of the present invention will be described.

(Configuration of Multiprocessor System)

As illustrated in FIG. 1, a multiprocessor system 1 includes a shared memory 100, multiple accelerators 200, a host processor 300, a power supply unit 400, and an interconnection network 500 which interconnects these components.

The shared memory 100 is composed of a RAM (Random-Access Memory) and an I/O circuit. The shared memory 100 is configured to be accessible from each accelerator 200 and the host processor 300. For example, the shared memory 100 may also be provided inside each accelerator 200 or the host processor 300.

In the shared memory 100, data to be referred to when each component executes a program are stored. These pieces of data may be written by each component, read from an unillustrated storage device such as an HDD (Hard Disk Drive) or a ROM (Read-Only Memory), or downloaded from the outside through a network.

Each accelerator 200 includes a data transfer program storage memory 210, a data transfer unit 220, a local memory 230, a control register 240, and a vector calculation unit 250. In the embodiment, each accelerator 200 corresponds to an example of a “processor system” of the present invention. One or more accelerators may be configured on a chip so that the accelerator(s) can be separated from other components of the multiprocessor system 1.

The data transfer program storage memory 210 is composed of a RAM and an I/O circuit and includes a program area 212 and a program counter storage area 214.

The program area 212 stores each task included in a program for the data transfer unit. In the embodiment, each task is one machine instruction. Instead of or in addition to this, the task may be composed of two or more machine instructions.

The program counter storage area 214 is an area into which a value stored in a program counter 222 of the data transfer unit 220 is saved when the data transfer unit 220 executes interrupt processing.

The data transfer unit 220 includes the program counter 222. The data transfer unit 220 is configured to refer to the program counter 222 in order to recognize the address of a task to be executed next, and to refer to a task stored in the program area 212 using the address in order to execute the task. In the embodiment, this data transfer unit 220 is described as an example of “one task execution unit” of the present invention.

The program counter 222 is composed of a RAM and an I/O circuit. The program counter 222 stores an address of a task in the program area 212 to be executed next by the data transfer unit 220. When the completion of a task being executed by the data transfer unit 220 is detected, the program counter 222 calculates the address of a task to be executed next from the length of the task being currently stored, and stores the address.

Further, the data transfer unit 220 is configured to be able to store, in the control register 240, any one of a first clock frequency, a second clock frequency lower than the first clock frequency, and a clock frequency of zero (stop). The data transfer unit 220 is operating at the first clock frequency immediately after the startup.

Note that the meaning that one component “recognizes” information in the embodiment is that all kinds of arithmetic processing for acquiring the information are executed, such as that the one component reads information stored in the memory, that the one component receives the information from another component, that the one component executes predetermined arithmetic processing (calculation processing, search processing, or the like) on a signal received from the other component to derive the information, that the one component receives, from the other component, the information as the arithmetic processing result of the other component, and that the one component reads the information from the memory or the outside according to the received signal.

The local memory 230 is composed of a RAM and an 1/0 circuit. The local memory 230 is configured to be accessible from each component of the accelerator 200 including the local memory 230 and from the host processor 300. The local memory 230 includes a memory control circuit 232 which performs specific control upon access from the outside, a flag area 234 which stores flag information, a data area 236 which stores data. The local memory 230 corresponds to an example of a “flag storage unit” of the present invention, and the memory control circuit 232 corresponds to an example of a “control unit” of the present invention. Note that the flag area 234 and the data area 236 are dividedly illustrated for convenience of explanation, but the flag area 234 and the data area 236 may be configured by one hardware component.

The control register 240 is composed of a RAM and an I/O circuit. The control register 240 is configured to be accessible from each component of the accelerator 200 including the local memory 230 and from the host processor 300. The control register 240 stores information indicative of the operating states of the data transfer unit 220 and the vector calculation unit 250 of the accelerator 200 including the control register 240. Further, the control register 240 is configured to store the clock frequencies of the data transfer unit 220 and the vector calculation unit 250 of the accelerator 200 including the control register 240. The data transfer unit 220 and the vector calculation unit 250 can change the clock frequencies of themselves by referring to the control register 240.

The vector calculation unit 250 is configured to execute vector operations, scalar operations, and reading and writing of data from and to the local memory 230 according to a program for the vector calculation unit read from the local memory 230. In the embodiment, this vector calculation unit 250 is described as an example of “another task execution unit” of the present invention. In this case, a “plurality of task execution units” are configured to include the data transfer unit 220 and the vector calculation unit 250 of each accelerator.

The host processor 300 is configured to include a processor such as a central processing unit (CPU) which reads a program for the host processor stored in an internal register to execute tasks for the host processor stated in the program for the host processor according to the program for the host processor. The tasks for the host processor include a task for controlling the operation of each component.

The host processor 300 is configured to cause one or more accelerators 200 to execute interrupt processing according to an event such as a user's instruction entered through an unillustrated input unit.

The power supply unit 400 is configured to supply power to the shared memory 100, each accelerator 200, the host processor 300, and the interconnection network 500.

The power supply unit 400 refers to the clock frequency of each component stored in the control register 240 of each accelerator 200 to adjust the amount power to be supplied to each component of each accelerator 200 using a predetermined formula or a correspondence table. The power supply unit 400 may also be provided for each accelerator 200 and the host processor 300, respectively.

The interconnection network 500 is, for example, a bus a cross bus.

Note that the program for the data transfer unit, the program for the vector calculation unit and the program for the host processor are generated from one sequential execution program, respectively. More specifically, based on a process of analyzing the sequential execution program, a process of extracting the parallelism of each task from the control dependency and the data dependency, and the task execution cost such as the processing time and power consumption of each task or the degree of priority of the task, a parallelizing compiler causes a computer to execute a process of assigning a task to each of the data transfer unit 220, the vector calculation unit 250, and the host processor 300. Based on this task assignment, the parallelizing compiler causes the computer to generate the program for the data transfer unit, the program for the vector calculation unit, and the program for the host processor to realize parallel execution. As such a parallelizing compiler, for example, a parallelizing compiler disclosed in Japanese Patent Application Laid-Open No. 2007-328416 or Japanese Patent Application Laid-Open No. 2007-328415 can be used.

(Data Transfer Processing)

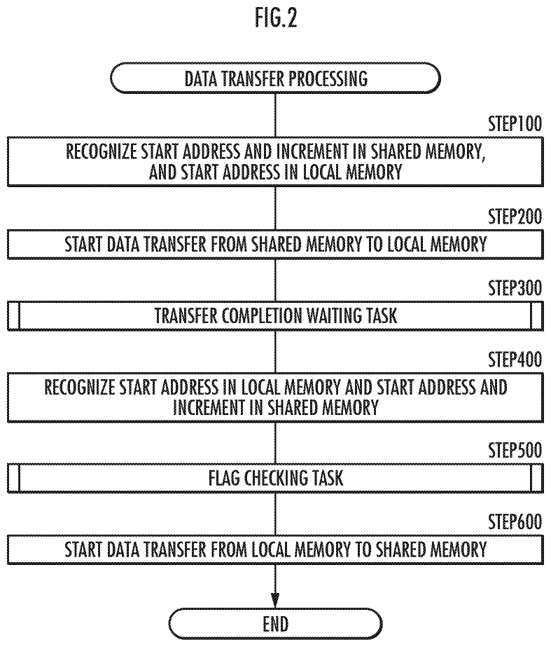

Referring next to FIG. 2, data transfer processing by the data transfer unit 220 will be described.

As generally stated, this data transfer processing is processing in which the data transfer unit 220 transfers data used in the vector calculation unit 250 from the shared memory 100 to the local memory 230, and transfers, to the shared memory 100, data stored in the local memory 230 by the vector calculation unit 250 after completion of processing by the vector calculation unit 250.

First, according to a task read from the program area 212, the data transfer unit 220 recognizes the start address and the address increment in the shared memory 100 with target data stored therein, and the start address in the data area 236 in the local memory 230 as the storage location of the read data (FIG. 2/STEP100). The target data are, for example, a one-dimensional array. In this case, the increment is a value determined according to the size of each piece of data stored in the one-dimensional array and the element to be accessed. The target data may be a scalar variable, a two-dimensional or higher dimensional array, or any other data. Note that data are continuously stored in the data area 236 of the local memory 230 to enable the vector calculation unit 250 to access the data fast in order to start the next process included in the program for the vector calculation unit.

According to the start address and the address increment in the shared memory 100 with the target data stored therein, and the start address in the data area 236 of the local memory 230 as the storage location of the read data, the data transfer unit 220 starts data transfer (FIG. 2/STEP200). During data transfer, a value indicative of the transfer state (for example, 1) is set in transfer state information indicative of the state of the data transfer unit 220 stored in the control register 240, while when data transfer is not performed, a value indicative of a state of not being transferred (for example, 0) is set in the transfer state information.

Next, the data transfer unit 220 executes a transfer completion waiting task (FIG. 2/STEP300). The details of the transfer completion waiting task will be described later. By the execution of the transfer completion waiting task, the data transfer unit 220 can suspend the start of execution of a task to be executed next until data transfer in FIG. 2/STEP200 is completed.

After the process of FIG. 2/STEP300, the data transfer unit 220 recognizes the start address of reading target data in the data area 236 of the local memory 230, and the start address and the increment in the data storage location of the shared memory 100 (FIG. 2/STEP400).

The data transfer unit 220 executes a flag checking task (FIG. 2/STEP500). The details of the flag checking task will be described later. By the execution of the flag checking task, the data transfer unit 220 can start data transfer in FIG. 2/STEP600 after completion of the processing of the vector calculation unit 250.

The data transfer unit 220 starts data transfer according to the start address of reading target data in the data area 236 of the local memory 230, and the start address and the increment in the data storage location of the shared memory 100 (FIG. 2/STEP600). Note that “FIG. 2/STEP600” corresponds to a “task following the flag checking task” of the present invention.

(Transfer Completion Waiting Task)

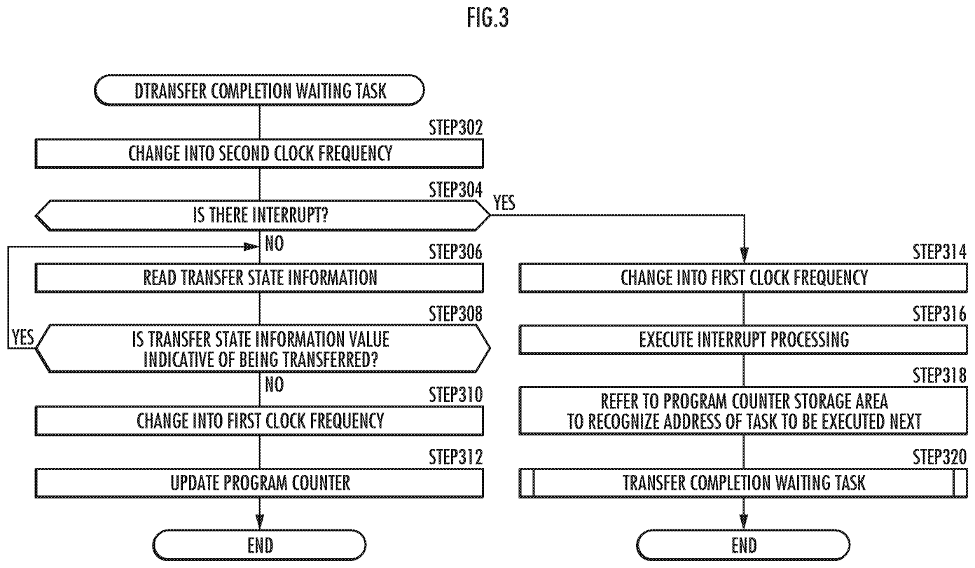

Referring next to FIG. 3, the details of the transfer completion waiting task in FIG. 2/STEP300 will be described. Note that the program counter 222 stores the address of the “transfer completion waiting task” at the start of execution of this processing.

The data transfer unit 220 accesses the control register 240 to change its own clock frequency to a second clock frequency (FIG. 3/STEP302). Thus, the power supply unit 400 refers to this updated clock frequency to operate so as to reduce the amount of power supplied to the data transfer unit 220.

The data transfer unit 220 determines whether there is interrupt processing or not (FIG. 3/STEP304).

When the determination process is negative (FIG. 3/STEP304 . . . No), the data transfer unit 220 refers to the control register 240 to read transfer state information (FIG. 3/STEP306).

The data transfer unit 220 determines whether the transfer state information is a value indicative of being transferred (FIG. 3/STEP308).

When the determination result is affirmative (FIG. 3/STEP308 . . . YES), the data transfer unit 220 executes processes in FIG. 3/STEP304 and subsequent steps.

When the determination result is negative (FIG. 3/STEP308 . . . NO), the data transfer unit 220 accesses the control register 240 to change the clock frequency of the data transfer unit 220 into the first clock frequency (FIG. 3/STEP310). Thus, the power supply unit 400 refers to this updated clock frequency to operate so as to increase the amount of power supplied to the data transfer unit 220.

After FIG. 3/STEP310, the data transfer unit 220 updates the program counter 222 to cause the program counter 222 to indicate a task (the task in FIG. 2/STEP400) to he executed next (FIG. 3/STEP312), and ends the transfer completion waiting task.

Further, when the determination result of FIG. 3/STEP304 is affirmative (FIG. 3/STEP304 . . . YES), the data transfer unit 220 accesses the control register 240 to change the clock frequency of the data transfer unit 220 into the first clock frequency (FIG. 3/STEP314). Thus, the power supply unit 400 refers to this updated clock frequency to operate so as to increase the amount of power supplied to the data transfer unit 220.

The data transfer unit 220 execute interrupt processing (FIG. 3/STEP316). Before executing the interrupt processing, the data transfer unit 220 saves the value of the program counter 222 to the program counter storage area 214.

After completion of the interrupt processing, the data transfer unit 220 refers to the program counter storage area 214 to recognize the address of a task to be executed next in the program area 212 (FIG. 3/STEP318). The recognized address is stored in the program counter 222. Here, the program counter storage area 214 stores the address of the “transfer completion waiting task” unless the program counter 222 is updated in the interrupt processing after the start of execution of the transfer completion waiting task.

The data transfer unit 220 reads, from the program area 212, and executes the “transfer completion waiting task” indicated by the read address of the task (FIG. 3/STEP320). The transfer completion waiting task is not accompanied by updating information except the clock frequency of the data transfer unit 220, and the clock frequency of the data transfer unit 220 is also a value for specifying the operating state of the data transfer unit 220. Therefore, even if the transfer completion waiting task is re-executed, data inconsistency will not occur.

(Flag Checking Task)

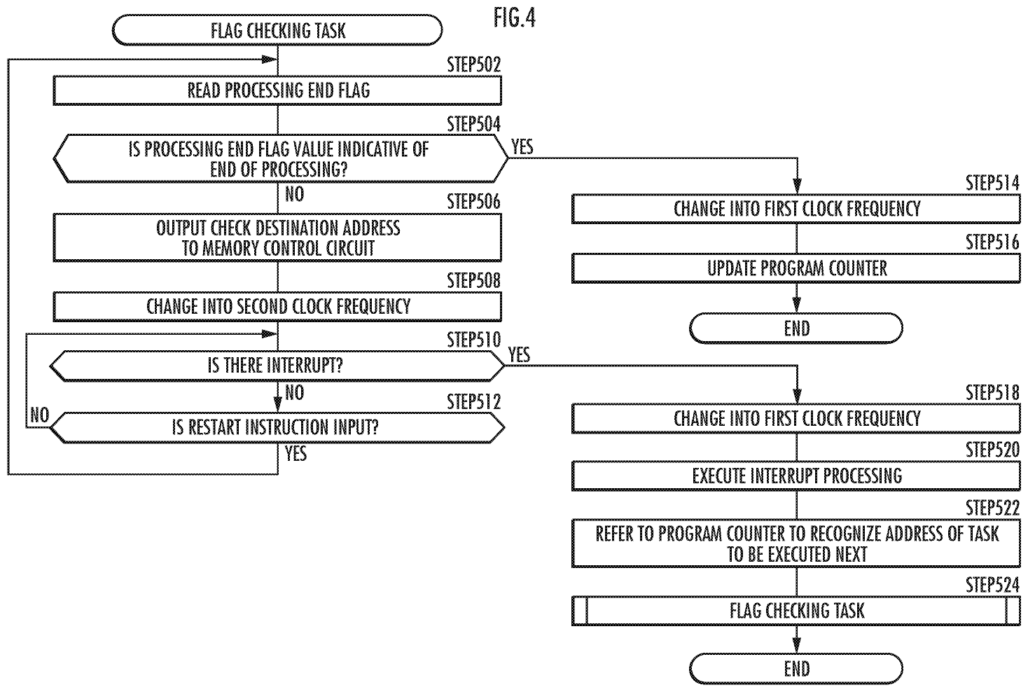

Referring to FIG. 4, the details of the flag checking task in STEP500 of FIG. 2 will be described. Note that the program counter 222 stores the address of the “transfer completion waiting task” at the start of execution of this processing.

The data transfer unit 220 reads a processing end flag from the flag area 234 of the local memory 230 (FIG. 4/STEP502). This processing end flag is stored in the flag area 234 of the local memory 230 by specifying the address of the flag area 234 in the program for the data transfer unit in advance. The initial value of the processing end flag is a value (for example, zero) indicating that the processing is not ended. Upon completion of the specifying process, the vector calculation unit 250 updates the processing end flag to a value (for example, 1) indicating that the processing is ended. The processing end flag corresponds to an example of “flag information” of the present invention.

The data transfer unit 220 determines whether the processing end flag is the value indicating that the processing is ended or not (FIG. 4/STEP504).

When the determination is negative (FIG. 4/STEP504 . . . NO), the data transfer unit 220 outputs, to the memory control circuit 232, the address at which the processing end flag is stored in the flag area 234 (FIG. 4/STEP506). The memory control circuit 232 is configured to output a processing restart instruction to the data transfer unit 220 when there is a write access to the address. The details of processing of the memory control circuit 232 will be described later. Note that the “address at which the processing end flag is stored in the flag area 234” corresponds to an example of a “signal indicating that flag information is being monitored” of the present invention.

The data transfer unit 220 accesses the control register 240 to change the clock frequency thereof into a second clock frequency (FIG. 4/STEP508).

The data transfer unit 220 determines whether there is interrupt processing or not (FIG. 4/STEP510).

When the determination result is negative (FIG. 4/STEP510 . . . NO), the data transfer unit 220 determines whether there is input of a restart instruction from the memory control circuit or not (FIG. 4/STEP512).

When the determination result is affirmative (FIG. 4/STEP512 . . . YES), the data transfer unit 220 executes processes in FIG. 4/STEP502 and subsequent steps.

On the other hand, when the determination result is negative (FIG. 4/STEP512 . . . NO), the data transfer unit 220 executes processes in FIG. 4/STEP510 and subsequent steps.

Further, when the determination result in FIG. 4/STEP504 is affirmative (FIG. 4/STEP510 . . . YES), the data transfer unit 220 accesses the control register 240 to change the clock frequency of the data transfer unit 220 into the first clock frequency (FIG. 4/STEP514). Thus, the power supply unit 400 refers to this updated clock frequency to operate so as to increase the amount of power supplied to the data transfer unit 220.

After FIG. 4/STEP514, the data transfer unit 220 updates the program counter 222 to cause the program counter 222 to indicate a task (task in FIG. 2/STEP600) to be executed next (FIG. 4/STEP516), and ends the flag checking task.

Further, when the determination result in FIG. 4/STEP510 is affirmative (FIG. 4/STEP510 . . . YES), the data transfer unit 220 accesses the control register 240 to change the clock frequency of the data transfer unit 220 into the first clock frequency (FIG. 4/STEP518). Thus, the power supply unit 400 refers to this updated clock frequency to operate so as to increase the amount of power supplied to the data transfer unit 220.

The data transfer unit 220 executes interrupt processing (FIG. 4/STEP520). The data transfer unit 220 saves the value of the program counter 222 to the program counter storage area 214 before execution of the interrupt processing.

After completion of the interrupt processing, the data transfer unit 220 refers to the program counter storage area 214 to recognize the address of a task to be executed next in the program area 212 (FIG. 4/STEP522). The read address is stored in the program counter 222. Here, the program counter storage area 214 stores the address of the “flag checking task” unless the program counter 222 is updated in the interrupt processing after the start of execution of the flag checking task.

The data transfer unit 220 reads, from the program area 212, the “flag checking task” indicated by the read address of the task, and executes the task (FIG. 4/STEP524). Like the transfer completion waiting task, the flag checking task is not accompanied by updating information except the clock frequency of the data transfer unit 220 and the address of the processing end flag. Then, the clock frequency of the data transfer unit 220 is a value for specifying the operating state of the data transfer unit 220. Further, the address of the processing end flag is registered in the memory control circuit 232. However, since the memory control circuit 232 outputs a restart instruction to the data transfer unit 220 when there is a write access to the address of the processing end flag, the content of other data is not affected. therefore, even if the flag checking task is re-executed, data inconsistency will not occur.

(Access Check)

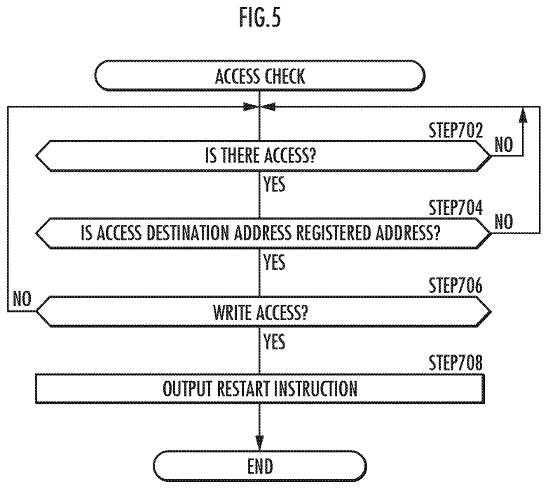

Referring next to FIG. 5, the details of an access check executed by the memory control circuit 232 after the address at which the processing end flag is stored in the flag area 234 is registered in the memory control circuit 232 (FIG. 4/STEP506) will be described.

The memory control circuit 232 determines whether there is an access to the local memory 230 or not (FIG. 5/STEP702).

When the determination result is negative (FIG. 5/STEP702 . . . NO), the memory control circuit 232 executes processes in FIG. 5/STEP702 and subsequent steps again.

When the determination result is affirmative (FIG. 5/STEP702 . . . YES), the memory control circuit 232 determines whether the address of the access destination is an address registered in the flag area 234 (the address of the processing end flag) or not (FIG. 5/STEP704).

When the determination result is negative (FIG. 5/STEP704 . . . NO), the memory control circuit 232 executes processes in FIG. 5/STEP702 and subsequent steps again.

When the determination result is affirmative (FIG. 5/STEP7O4 . . . YES), the memory control circuit 232 determines whether the access is a write access or not (FIG. 5/STEP706).

When the determination result is negative (FIG. 5/STEP706 . . . NO), the memory control circuit 232 executes processes in FIG. 5/STEP702 and subsequent steps again.

When the determination result is affirmative (FIG. 5/STEP706 . . . YES), the memory control circuit 232 outputs a restart instruction to the data transfer unit 220 (FIG. 5/STEP708).

After the process in FIG. 5/STEP708, the memory control circuit 232 ends the access check.

### Operation and Effect of the Embodiment

According to the multiprocessor system 1 thus configured, when the task included in the program for the data transfer unit is the flag checking task (FIG. 2/STEP500), the data transfer unit 220 determines whether the processing end flag stored in the flag area 234 of the local memory 230 is the value indicative of the end of processing or not (FIG. 4/STEP504). The fact that the “processing end flag is the value indicative of the end of processing” corresponds to a “predetermined condition” of the present invention. The fact that the “flag is not a value indicating that the processing is in progress” may also be the “predetermined condition” of the present invention. Further, the fact that the “numerical value stored in the flag is equal to or less than a predetermined numerical value” may be the “predetermined condition” of the present invention.

When the processing end flag stored in the flag area 234 is the value indicative of the end of processing (FIG. 4/STEP504 . . . YES), a task following the flag checking task included in the program is executed by the data transfer unit 220.

Thus, the execution start timing of the task (FIG. 2/STEP600) following the flag checking task (FIG. 2/STEP500) can be adjusted properly.

Further, when the processing end flag stored in the flag area 234 is the value indicative of the end of processing, the data transfer unit 220 outputs, to the memory control circuit 232 of the local memory 230, the address of the processing end flag in the flag area 234 (FIG. 4/STEP506), and suspends access to the flag information.

Then, when a signal indicating that the flag information is being monitored is input from the data transfer unit 220, the memory control circuit 232 monitors the presence or absence of a write access to the flag information from the vector calculation unit 250 or the like (FIG. 5/STEP702 TO STEP706).

Then, when there is the write access to the flag information (FIG. 5/All YES in STEP702 TO STEP706), the memory control circuit 232 outputs, to the data transfer unit 220, an instruction for restarting access to the flag information (FIG. 5/STEP708).

Thus, since flag checking can be avoided while the flag information is not updated, the overhead of flag checking can be reduced compared with the case of frequent access to the flag area. In addition, when the flag information is updated, that is, when the fact that the processing end flag is the value indicative of the end of processing is highly probable, since the access of the data transfer unit 220 to the flag information is restarted, the standby time until the execution of the task (FIG. 2/STEP600) following flag checking can be shortened.

Further, according to the multiprocessor system 1 having the configuration, since a signal for reducing the amount of power to be supplied from the power supply unit 400 to the one task execution unit is output when access to the flag information is suspended, power consumption while the access to the flag information is being suspended is reduced.

Further, when processing is allocated properly to each program by a parallelization program and necessity for executing another processing upon waiting for processing is low, it is particularly preferred that the clock frequency be reduced as mentioned above to reduce the power consumption.

According to the multiprocessor system 1 thus configured, when there is interrupt processing during the suspension of access to the flag information (FIG. 4/STEP510 . . . YES), the interrupt processing is executed without updating the program counter 222 (FIG. 4/STEP518 AND STEP520). After that, the program counter 222 is referred to in order to recognize a task to be executed next (FIG. 4/STEP522).

Here, in the flag checking task (FIG. 4), the program counter 222 is updated (FIG. 4/STEP516) after it is determined that the flag information satisfies the predetermined condition (FIG. 4/STEP504 . . . YES AND LATER). Therefore, the program counter 222 is not updated during the suspension of access to the flag information (FIG. 4/STEP504 . . . NO).

In other words, the task indicated in the program counter 222 remains as flag checking task during the suspension of access to the flag information. Therefore, the flag checking task is recognized as the task to be executed next unless the program counter 222 is updated in the interrupt processing after completion of the execution of the interrupt processing.

Since the flag checking task is a task which is not accompanied by updating processing target data, data inconsistency will not occur even if the task is re-executed. This makes it possible to simplify processing at the time of interruption and upon restart of the interruption while executing the interrupt processing properly.

(Variations)

In the embodiment, the clock frequency of the, data transfer unit 220 is set to the second frequency during the suspension of access to the flag information (FIG. 4/STEP508). However, instead of this, the data transfer unit 220 may be stopped to shut off power from the power supply unit 400. In this case, it is preferred that the memory control circuit 232 be configured to output a start signal to the data transfer unit 220 as a restart instruction.

In the embodiment, the data transfer unit 220 is described as “one task execution unit” of the present invention. However, instead of or in addition to this, a processor, such as a CPU or a vector calculation unit, operating according to a task included in a program may be configured as “one task execution unit” of the present invention. Note that the program for the one task execution unit includes the flag checking task as a task preceding a certain task.

In the embodiment, the vector calculation unit 250 is described as “another task execution unit” of the present invention. However, instead of or in addition to this, a processor, such as a data transfer unit or a CPU, operating according to a task included in a program may be configured as “another task execution unit” of the present invention. Note that the program for the other task execution unit includes a task for updating the flag information stored in the flag area 234, such as a task for writing, into the flag area 234, the value indicating that the task is completed, as a task following a certain task.

In the embodiment, the accelerator 200 is described as a “processor system” of the present invention and the local memory 230 is described as a “flag information storage unit” of the present invention, but the multiprocessor system 1 may be configured as the “processor system” of the present invention, and a storage device, such as a shared memory 100, capable of storing flag information and including a control unit may be configured as a “flag information storage unit.” In this case, for example, a task execution unit (for example, the data transfer unit) included in the host processor or one accelerator may be configured as “one task execution unit” of the present invention, and a task execution unit (for example, the data transfer unit) included in the host processor or another accelerator may be configured as “another task execution unit” of the present invention.

In the embodiment, the memory control circuit 232 monitors the presence or absence of a write access to an address based on the “address in the flag area 234 with the processing end flag stored therein.” However, instead of this, the memory control circuit 232 may determine whether the processing end flag is the value indicative of the end of processing or not based on the “address in the flag area 234 with the processing end flag stored therein” and the “value indicative of the end of processing.” In this case, when it can be checked that the processing end flag is the value indicative of the end of processing, the data transfer unit 220 may be configured to execute the task following the flag checking task without re-executing the flag checking task.

In the embodiment, the memory control circuit 232 monitors the presence or absence of a write access to an address based on the “address in the flag area 234 with the processing end flag stored therein.” However, instead of this, the memory control circuit 232 may monitor the presence or absence of an access to an address based on the “address in the flag area 234 with the processing end flag stored therein.”

### DESCRIPTION OF REFERENCE NUMERALS

1 . . . multiprocessor system, 222 . . . program counter, 220 . . . data transfer unit (one task execution unit), 230 . . . local memory (flag storage unit), 232 . . . memory control circuit (control unit), 234 . . . flag area, 250 . . . vector calculation unit (another task execution unit), 400 . . . power supply unit, STEP500 . . . flag checking task, STEP600 . . . task following flag checking task.

1. A processor system comprising:
a plurality of task execution units configured to operate according to tasks included in a program;
a flag storage unit configured to include a flag area which stores flag information and a control unit which controls access to the flag area; and
a program counter configured to indicate a task to be executed next by one task execution unit in the plurality of task execution units, wherein
the program counter indicates a task being executed while the one execution unit is executing the task, and upon completion of the task being executed, the program counter is updated to indicate a task to be executed next by the one execution unit,
the flag storage unit stores, as the flag information, information indicative of the processing state of another task execution unit in the plurality of task execution units,
the one task execution unit determines whether flag information stored in the flag area satisfies a predetermined condition or not according to a flag checking task, and
in the case where the flag information stored in the flag area satisfies the predetermined condition, the one task execution unit starts execution of a task following the flag checking task, or
in the case where the flag information stored in the flag area does not satisfy the predetermined condition, the one task execution unit outputs, to the control unit of the flag storage unit, a signal indicating that the flag information is being monitored, and suspends access to the flag information without ending the flag checking task, and
in the case where the signal indicating that the flag information is being monitored is input from the one task execution unit, the control unit of the flag storage unit monitors the presence or absence of access to the flag information from the other task execution unit, and outputs, to the one task execution unit, an instruction to release the suspension of access to the flag information in the case where there is access to the flag information, and
the one task execution unit updates the program counter after determining in the flag checking task that the flag information satisfies the predetermined condition, and in the case where there is interrupt processing during the suspension of access to the flag information, the one task execution unit executes the interrupt processing without updating the program counter, and refers to the program counter after completion of the execution of the interrupt processing to recognize the task to be executed next.

2. The processor system according to claim 1, further comprising
a power supply unit which supplies power to the one task execution unit,
wherein upon suspending access to the flag information, the one task execution unit outputs a signal for reducing or shutting off the amount of power to be supplied from the power supply unit to the one task execution unit.

3. (canceled)

4. The processor system according to claim 1, wherein
the processor system is an accelerator provided on a chip,
the flag storage unit is a local memory including the flag area, the control unit, and a data area which stores data different from the flag information,
the one task execution unit is a data transfer unit configured to transfer data from the data area to the outside of the accelerator or transfer data from the outside of the accelerator to the data area, and
the other task execution unit is a calculation unit configured to read data stored in the data area, execute arithmetic processing according to a program based on the read data, store the arithmetic processing result in the data area, and update the value of the flag information.

5. A multiprocessor system comprising:
a plurality of the processor systems according to claim 1; and
a shared memory accessible from the plurality of the processor systems, respectively.
